(19) United States
(12) Patent Application Publication
(10) Pub. No.: US 2018/0082481 A1
(43) Pub. Date: Mar. 22, 2018

(54) PROCESS AND PLATFORM FOR LIDS

(71) Applicant: Wade & Company Inc., Toronto (CA)

(72) Inventor: Marc WADE, Stouffville (CA)

(21) Appl. No.: 15/708,683

(22) Filed: Sep. 19, 2017

Related U.S. Application Data
(60) Provisional application No. 62/396,522, filed on Sep. 19, 2016.
(60) Provisional application No. 62/405,321, filed on Oct. 7, 2016.

(51) Int. Cl. G06T 19/00

(52) U.S. Cl. CPC G06T 19/006; H04W 4/021

(57) ABSTRACT

Embodiments provide an augmented reality system and process that involves a lid with machine readable indicia, a computing device with an application to capture and process the machine readable indicia and a remote server to generate a customized augmented reality experience. The augmented reality experience is generated based on one or more unique identifiers and machine readable indicia to provide a dynamic and engaging user experience.

### CROSS REFERENCE TO RELATED APPLICATIONS

This applications claims priority to and the benefit of U.S. Provisional Application No. 62/396,522 filed Sep. 19, 2016 and U.S. Provisional Application No. 62/405,321 filed Oct. 7, 2016, the entire contents of each of which is hereby incorporated by reference.

### FIELD

The present disclosure generally relates to the field of object recognition and augmented reality and, in particular, to augmented reality systems involving lids of beverage containers, and production of the lids for such systems.

### INTRODUCTION

Advertisements and loyalty programs should engage consumers. Consumers regularly carry and use smartphones and other mobile devices. Consumers also drink beverages with lids. Lids of beverage containers provide a mechanism to deliver advertisements and loyalty program content. Lids are often disposable and low cost items.

### SUMMARY

In accordance with one aspect, there is provided an augmented reality system triggered by a lid with machine readable indicia. A computing device with an application and sensors captures and process the machine readable indicia. The device can interact with a remote server to generate a customized augmented reality experience based on one or more unique identifiers and the machine readable indicia.

In accordance with another aspect, there is provided an augmented reality process comprising: collecting data relating to readable indicia and one or more unique identifiers and historical or preference data; providing the data to an application and/or a remote computer; processing the data to generate an augmented reality experience; delivering the augmented reality experience using the application and/or the remote computer; collecting activity data for the augmented reality experience; and updating the augmented reality experience based on the collected activity data.

In various further aspects, the disclosure refers to various systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIGS. 1a, 1b, 1c, 1d, 1e, 1f are diagrams of example lids with machine readable indicia for augmented reality according to some embodiments;

FIG. 2 is a schematic diagram of an example augmented reality system involving lids for beverage containers according to some embodiments;

FIG. 3 is a schematic diagram of an example computing device for an augmented reality system according to some embodiments;

FIG. 4 is a schematic diagram of an example augmented reality system according to some embodiments;

FIG. 5 is a schematic diagram of another example augmented reality system according to some embodiments;

FIG. 6 is a schematic of computing device according to some embodiments;

FIG. 7 is a schematic of image recognition utility according to some embodiments;

FIG. 8 is a workflow diagram of an example process involving lids for beverage containers according to some embodiments;

FIG. 9 is a workflow diagram of an example process involving lids for beverage containers according to some embodiments; and

FIG. 10 is a schematic of a remote computer 3100 according to some embodiments.

### DETAILED DESCRIPTION

Embodiments of methods, systems, and apparatus are described through reference to the drawings.

Embodiments described herein relate to a lid with indicia readable by a computing device to provide an engaging interactive augmented reality experience. Embodiments described herein provide processes for the lids and system.

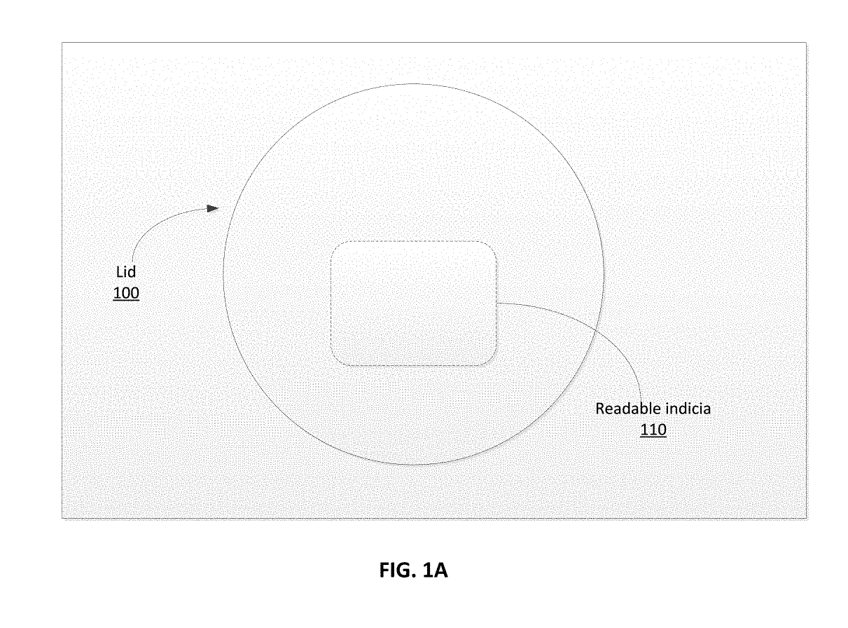

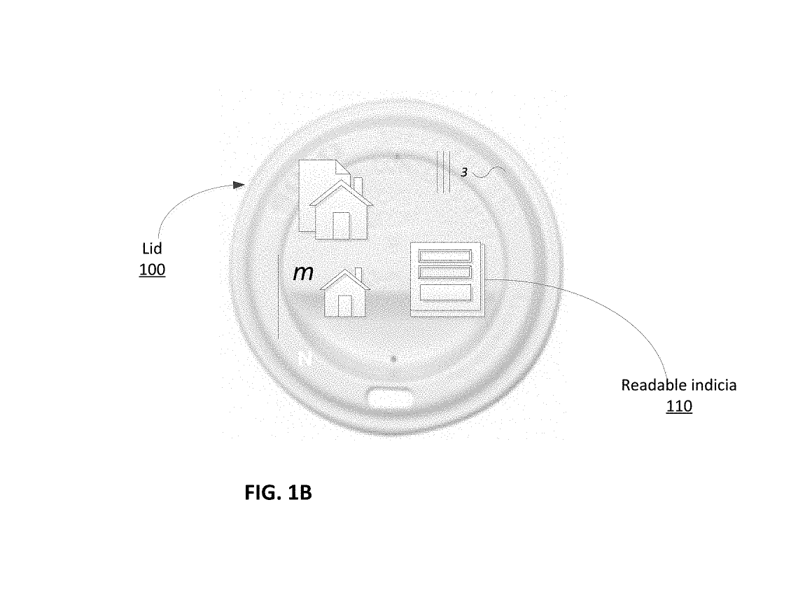

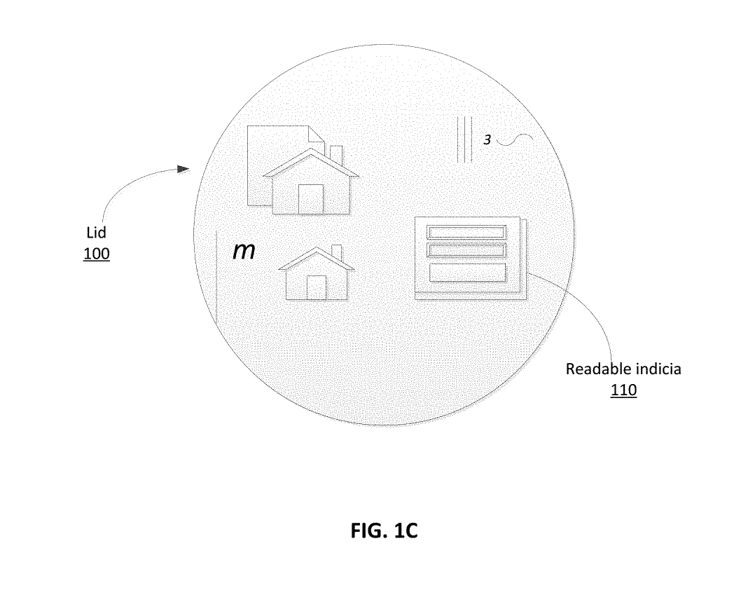

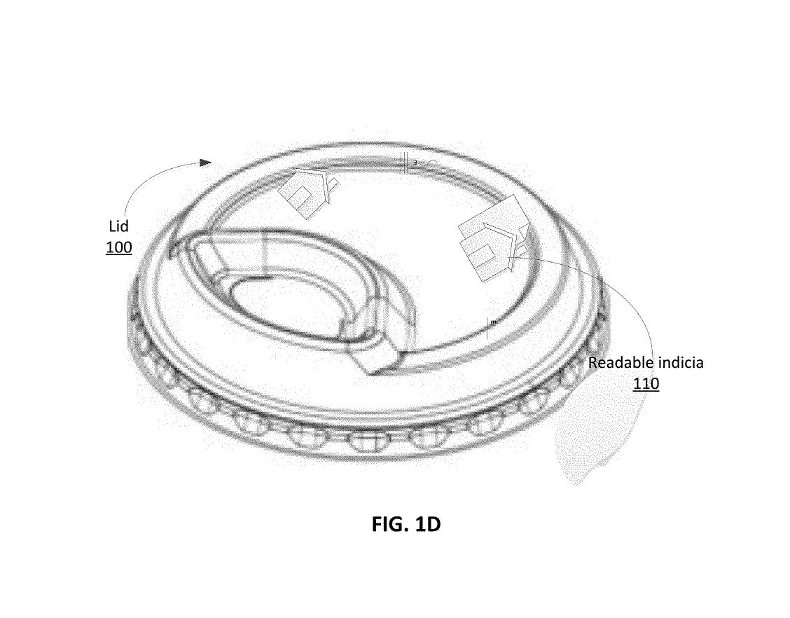

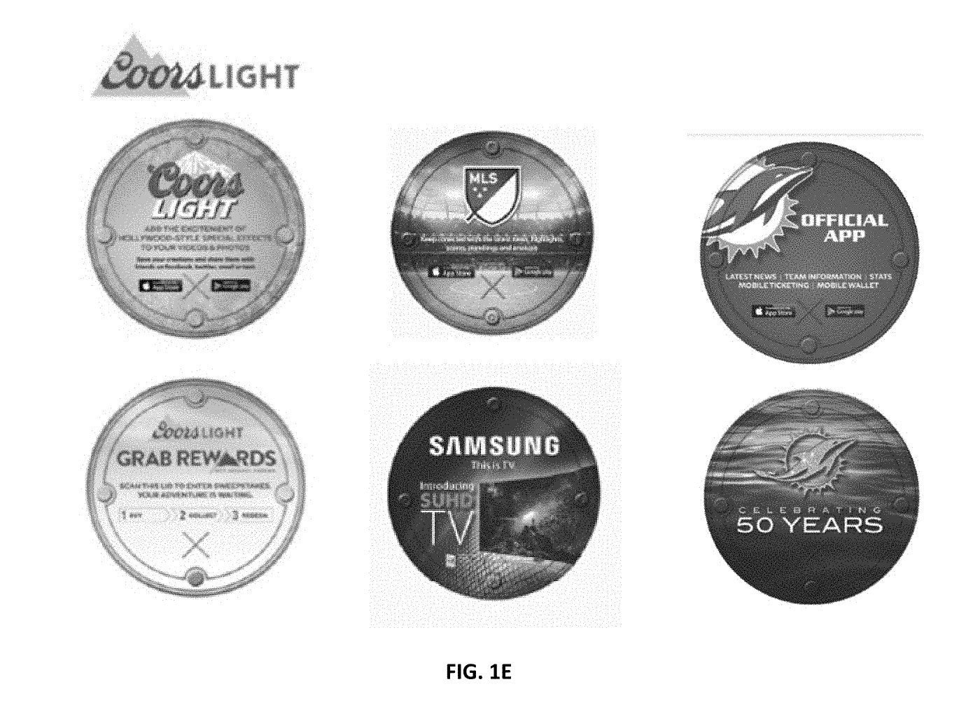

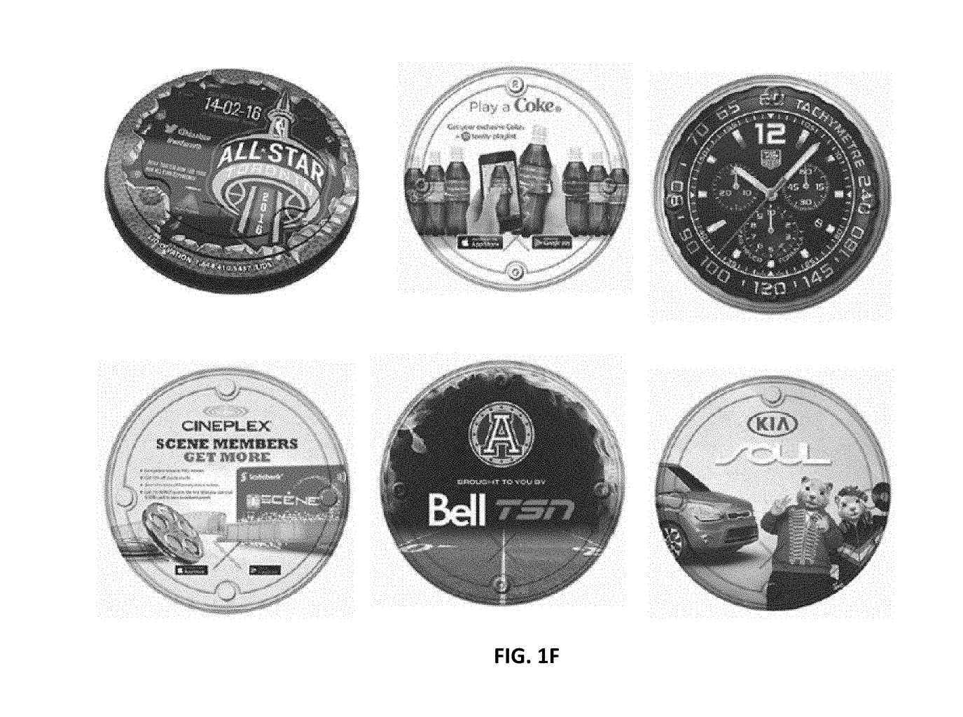

FIG. 1a is a diagram of an example lid 100 with machine readable indicia 110 for triggering an augmented reality experience according to some embodiments. Lid 100 is configured to engage with and enclose or cover a container, such as a disposable beverage container, for example. The beverage container may be for different types of beverages such as coffee, tea, juice, pop, beer, wine, cider and the like.

The machine readable indicia 110 can be a watermarks, identifiers or signatures that are added to the lid 100 during the printing process. The watermarks can be invisible to the human eye but not to configured devices 200. Embodiments relate to the process of printing on thermoformed lids, and combining it with readable indicia 110 (invisible watermarks) to create augmented digital experiences that will transform traditional media assets into unique, engaging and creative activations that will grab audience attention. This can allow consumers to experience interactive brand moments that are both actionable and memorable. The augmented reality requires the layering of digital assets information on physical materials assets using sensors of devices 200. This can make static advertising materials come to life, for example. The user device can interact with lid 100 using readable indicia 110 for a chance to win an experience during a sporting event, playback or unlock media or receive prizes, for example. The user of augmented reality creates digital experiences from traditional media to engage consumers. This shortens the path to conversion and connects physical lid artwork to online channels with an augmented reality experience that directs customers to points of sale and any other venue advertising, landing pages, social engagement channels and many more 3D animations, it will increase product purchase and brand visibility in the market.

As shown in FIG. 1b lid 100 has a surface with three dimensional contours and machine readable indicia 110 thereon. The machine readable indicia 110 has contours from being printed on the lid 100. This may adjust or change visual presentation of an image depicted by machine readable indicia 110.

According to some embodiments, as shown in FIG. 1c an image is printed on lid 100 with an initial size and shape. Once the lid 100 is formed with the three dimensional contours the image transforms into machine readable indicia 110 with a different size and shape based on the contour. The initial image may be configured to accommodate the three dimensional contour surface of the machine readable indicia 110 when viewed by a consumer of the beverage within the container covered by the lid 100. The transformed machine readable indicia 110 generates a signature or signal pattern that is detectable by device. A machine for manufacturing the lids 100 with machine readable indicia 110 has access to a digital asset defining the signature or signal pattern for the machine readable indicia 110. This digital asset is used to control the transfer process to print or otherwise fix machine readable indicia 110 to lid 100. FIG. 1d shows machine readable indicia 110 on a contoured lid 100. FIGS. 1e and 1f show other example machine readable indicia 110 on the three dimensional contour surface of lid 100.

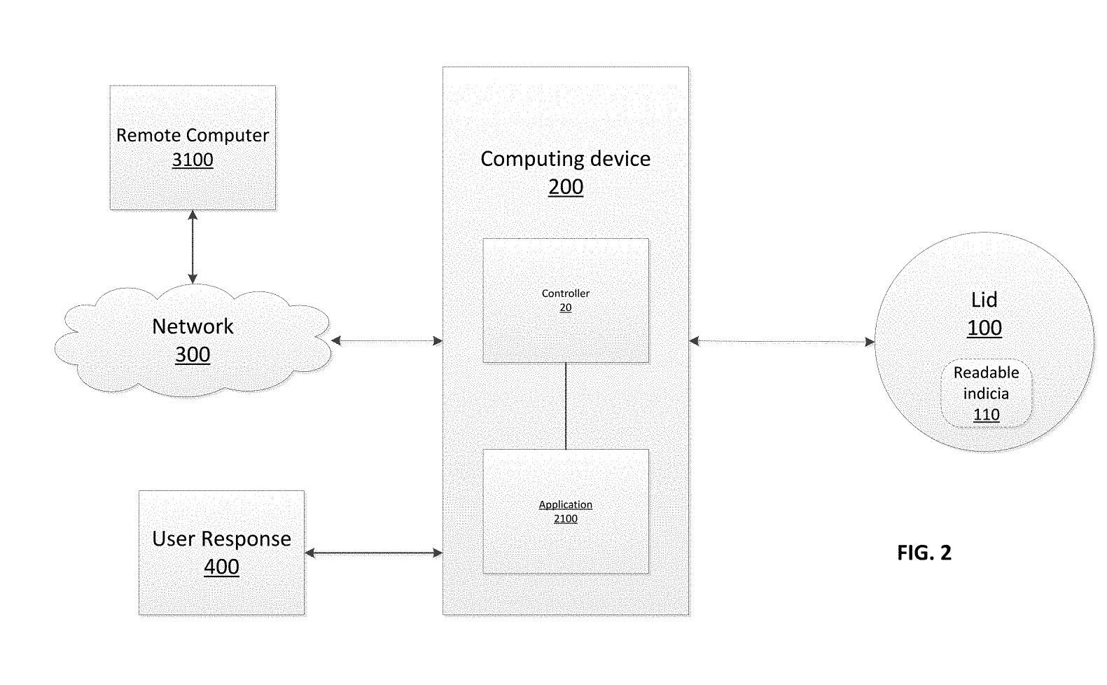

FIG. 2 is a schematic diagram of an example augmented reality system involving lids 100 for beverage containers according to some embodiments. The lids 100 interact with computing device 200. For example, computing device 200 reads readable indicia 110 to trigger an interactive augmented reality experience.

Remote computer 3100 defines a geo-fenced zone for a physical space. For example, the lid 100 may be for a beverage container sold in a stadium during a sporting event. Remote computer 3100 defines a geo-fenced zone for the stadium and tracks computing device 200 within the zone. Remote computer 3100 defines a geo-fenced zone to track other devices and generate augmented reality experiences. When computing device 200 enters the geo-fenced zone it may enable an interactive augmented reality experience customized to the particular geographical area. For example, the geo-fenced zone may be a region of a stadium with seats that are modeled using a digital mapping structure with coordinate values corresponding to the seats. Remote computer 3100 uses the digital mapping structure to accurately track devices within the region and link devices to seat locations based on detected location data, for example. Remote computer 3100 provides an advanced data analytics tool based on tracking data within the geo-fenced zone. Remote computer 3100 can receive data from other geo-fenced zones and aggregate the data.

Remote computer 3100 starts tracking device 200 when it enters geo-fenced zone. Remote computer 3100 accesses each device's 200 assigned Universal Unique Identifier (UUID). The UUID linked to device 200 can be at the time of manufacture. Remote computer 3100 can track location of device 200 and points of interest to capture tracking data that can be linked to user demographics. UUIDs enable distributed systems to uniquely identify information without significant central coordination. Remote computer 3100 can connect with other computers to generate a distributed system, for example and uniquely identify device information using UUIDs. Remote computer 3100 uses geo-fencing and passive tracking technologies to collect visitor data using device 200. Remote computer 3100 processes tracked data to generate graphical representations on a user dashboard, and suggests optimization of actionable data for custom augmented reality experiences.

Remote computer 3100 can aggregate real-time data with historical data to capture visitor metrics (number of visits, average duration of visit, positions within geo-fenced area), such as date, time, device attributes, user attributes, local data, video, images, audio, application data, and so on, to develop a content rich user profile. These elements may be incorporated into the augmented reality experiences to personal the experience. Remote computer 3100 can filter and transform data to generate device metrics and attributes and connected to other data sets using common identifiers, such as inventory and purchase transaction data. The metrics and attributes can be used to tailor the augmented reality experience and generate graphical representations.

The computing device 200 within the geo-fenced zone captures the readable indicia 110 to trigger an interactive augmented reality experience. This may be at a stadium for a live event to physically enhance the experience. The interactive augmented reality experience can generate different visual and audio effects using the computing device 200 or another computing device. The interactive augmented reality experience can be tailored based on the device 200 and historical tracking and demographic data to generate a targeted user experience. Additional input data can trigger modifications to the interactive augmented reality experience such as for example music playing in the background. The computing device 200 can have a microphone or other sensor to detect the background music and identify the song, for example. Additional input data can include a data stream for the sporting event, such as the game play time or the occurrence of an event within the game, such as a goal. Different events can trigger changes to the augmented reality experience to provide an interactive and dynamic experience. Remote computer 3100 can access a large data repository of elements of the augmented reality experience to combine different elements. The lids 100 can be sold at or proximate the geo-fenced zone.

In some embodiments, lid 100 is created by thermoforming material printed with readable indicia 110. In some embodiments, a material, such as high density polyethylene is processed, printed with indicia 110, heated, molded, cooled, and cut into lid 100. In some embodiments, the material may be heated, molded, and/or cooled one or more times before the material may be cut into lid 100. The material may be cooled, for example, to allow subsequently cut lid 100 to engage with a container. For example, the material may be cooled in a shape that covers and attaches to a beverage container. In some embodiments, one or more lids 100 may be thermoformed and printed simultaneously.

Readable indicia 110 may be applied to or printed on lid 100, or otherwise integrated with lid 100. The readable indicia 110 may be machine readable by a computing device 200 (FIG. 2); a sensor 250; an application on computing device 200 or other electromechanical component. Readable indicia 110 may be created and integrated with lid 100 before, during, or after creation of lid 100. Readable indicia 110 may be associated with lid 100 and/or material processed to create lid 100. For example, readable indicia 110 may be printed on the material at a specific location and/or orientation. For example, one or more readable indicia 110 may be printed on the material in one or more locations that will form part of one or more lids 100. Multiple readable indicia 110 may be printed on the material in multiple locations to form part of multiple lids 100. The multiple readable indicia will be printed at multiple positions based on markings or other indicators on material. In some embodiments, readable indicia 110 may cover the entire surface of lid 100. In some embodiments, one or more readable indicia 110 may have one or more specific orientations on lid 100. There may be multiple readable indicia on a single lid 100 in a corresponding multiple positions and/or orientations.

Readable indicia 110 are adaptable to hot or cold conditions, and moist conditions so that the indicia 110 do not become distorted and no longer readable by the beverage in the container. Readable indicia 110 may be safe for human consumption or contact. Readable indicia 110 are integrated with lid 100 during the production of lid to avoid application errors in correct positioning or orientation and to maintain hygiene conditions of the lid 100 production, packaging and distribution. The ink may be in different colors and applied in layers to generate the readable indicia 110. The ink may be invisible to the human eye and detectable by computing device 200. Readable indicia 110 are created using a medium capable of storing data in a format readable by a mechanical or machine device. Readable indicia 110 include optical codes (e.g. cryptographic barcodes), vouchers, characters or patterns, magnetic media, printed matter, microchips, radio transmission media, electromagnetic media, digital signatures, and a combination of these.

In some embodiments, readable indicia 110 include matter applied to or printed on material that will be formed to create lid 100. For example, ink may be printed on material that then may be thermoformed into a shape that transforms or arranges the ink into readable indicia 110 during processing. Accordingly, ink may be transformed into readable indicia 110 during forming of the lid 100. In some embodiments, a process for printing ink on material may be repeated one or more times before a process for creating and thermoforming lid 100 is performed and/or completed. In some embodiments, other non-readable indicia and/or ink (different than readable indicia 110 on the lid 100) may be printed on material that will be thermoformed to create lid 100 to enhance the readable indicia 110 and/or lid 100.

In some embodiments, a location of readable indicia 110 may be chosen to facilitate and/or enable readability by a computing device 200 and/or an application 2100. For example, a computing device 200 may recognize, detect or read one or more readable indicia 110, for example, when located in proximity to readable indicia 110, and/or when a sensor 250, camera or other hardware component views and/or captures readable indicia 110. The computing device 200 may process and/or transmit data relating to said readable indicia 110 to application 2100 and/or a remote computer 3100. Remote computer 3100 and aggregate this data with the tracking data to further enhance data set. The computing device 200 may capture other data and link the data to readable indicia 110, such as the geographical location of the lid 100 (via e.g. GPS on computing device 200), an image of a user, time and date, and so on. This data may also be provided to application 2100 and/or a remote computer 3100.

The matter printed on material for readable indicia 110 on lid 100 may be visible or invisible. In some embodiments, the matter (e.g. ink) is modified by the creation of lid and the surface with three dimensional contours. In some embodiments, the printed matter may contribute to, assist, and/or enable readability by computing device 200, sensor 250, application 2100, and/or remote computer 3100. In some embodiments, the creation of lid 100 may not alter any contribution, assistance, and/or enablement by ink to its readability by computing device 200, sensor 250, application 2100, and/or remote computer 3100. For example, said ink may be fully or partially heat resistant. The matter may be applied using three-dimensional printing devices.

In some embodiments, ink printed on material used to create lid 100 may create an offset from the material and/or lid 100, for example, a colour offset. In some embodiments, the ink may be nitro-cellulose solvent, ultraviolet curable, oil-based, and/or water-based. In some embodiments, the ink may not hinder the printing of ink on said material and/or the ink may not hinder the creation of lid 100.

In some embodiments, indicia, for example, registration marks, may be associated with one or more locations on lid 100, for example, to assist and/or enable positioning of readable indicia 110 as it relates to an association or future association with lid 100 and/or material processed to create lid 100. For example, registration marks may be located on the material to enable positioning of readable indicia 110 within a lid 100 and/or positioning of one or more layers of ink printed on material that may be used to create lid 100. The readable indicia 110 has one or more locations and orientations on the lid 100 to be readable by computing device 200.

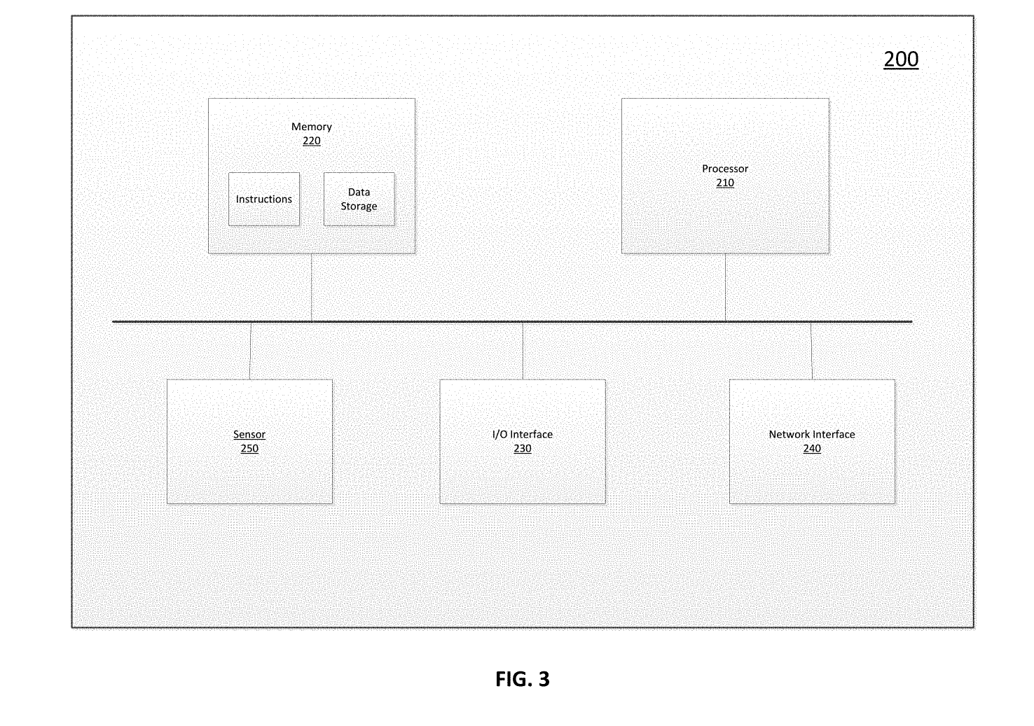

FIG. 3 is a schematic diagram of an example computing device 200 for an augmented reality system according to some embodiments. As depicted, computing device 200 includes at least one processor 210, memory 220, at least one I/O interface 230, at least one network interface 240, and sensors 250 for capturing readable indicia 110.

Each processor 210 may be, for example, any type of general-purpose microprocessor or microcontroller, a digital signal processing (DSP) processor, an integrated circuit, a field programmable gate array (FPGA), a reconfigurable processor, or any combination thereof.

Memory 220 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 230 enables computing device 200 to interconnect with one or more sensors 250 or other input devices, such as a keyboard, mouse, camera, touch screen and a microphone, or with one or more output devices such as a display screen and a speaker.

Each network interface 240 enables computing device 200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WMAX), SS7 signaling network, fixed line, local area network, wide area network, and others, including any combination of these.

Computing device 200 is operable to register and authenticate users (using a login, unique identifier, and password for example) prior to providing access to applications, a local network, network resources, other networks and network security devices. Computing devices 4 may serve one user or multiple users.

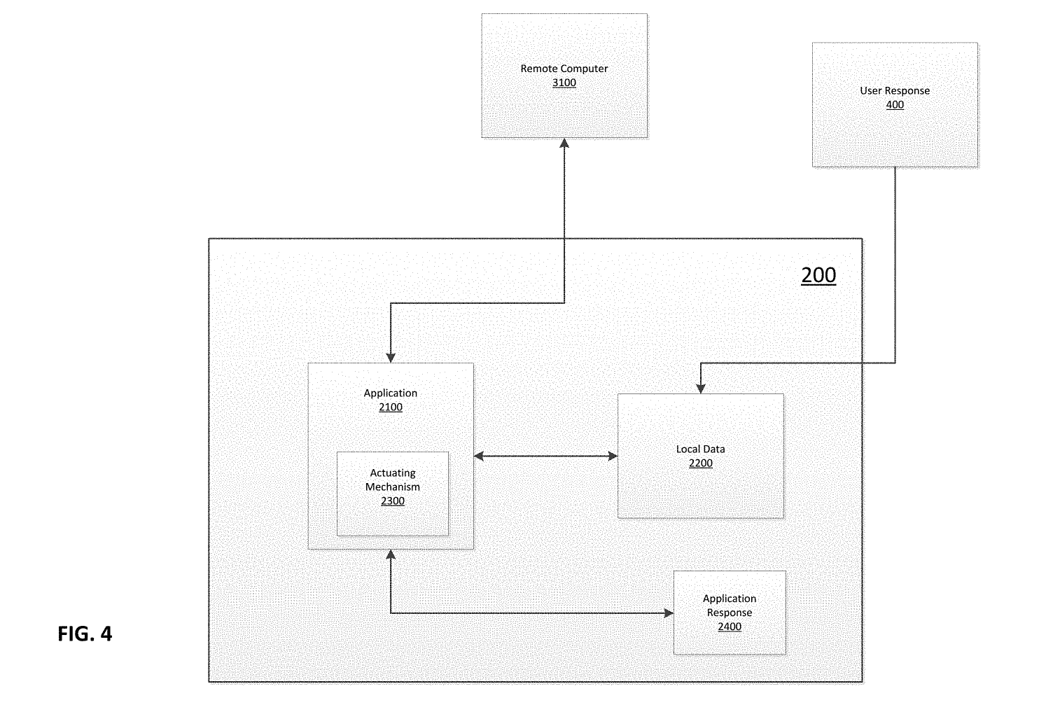

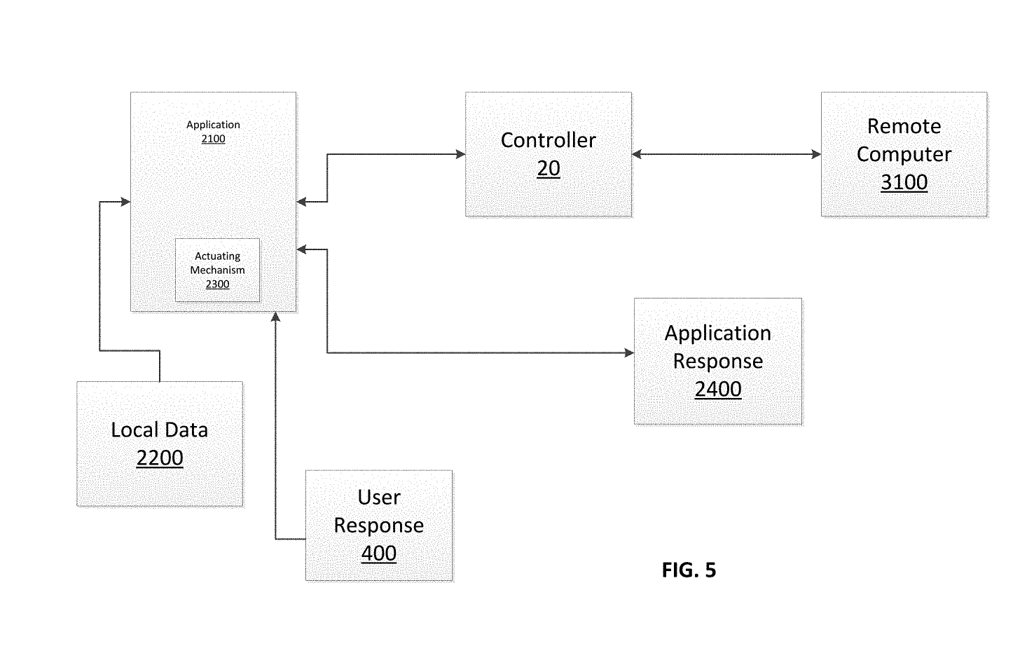

FIGS. 4 and 5 are schematic diagrams of example augmented reality systems according to some embodiments. The augmented reality system involves dynamic interaction between the lid 100 (including readable indicia 110) and an application 2100 on computing device 200. The application 2100 configures object detection and recognition to capture the readable indicia 110. The application 2100 engages sensors 250 to capture a digital image of the lid 100. The image may include background data. The application 2100 filters the image to remove background data and segments the image to focus on section depicting lid 100. The application 2100 generates a digital signature from the segment of the image depicting the readable indicia 110 on the lid 100. The application 2100 compares the digital signature to known digital signatures linked to different indicia. The known digital signatures may be used by application 2100 as training data to improve its object recognition of the readable indicia 110. The known digital signatures may be used by application 2100 to process the segment of the image depicting the readable indicia 110 to generate the digital signature to detect the readable indicia 110. For example, readable indicia 110 may provide an illustration for an advertisement with details that may be unclear or blurry in the image. The known digital signatures may be used by application 2100 as training data to generate similarity thresholds. If the captured image of the segment of the image depicting the readable indicia 110 on the lid 100 matches a known digital signature within the similarity threshold then the application 2100 will recognize the readable indicia 110 as being linked to the known digital signature. The known digital signature may be associated with a machine identifier that triggers different augmented reality experience elements. The known digital signature may be linked to other attributes, including type of drink, customer, team, city, country, region, and the like. The device profile may be updated with data for the known digital signature.

Embodiments described herein use unique identifiers and readable indicia to generate customized augmented reality experiences and responses. Lid 100 or readable indicia 110 thereon may be associated with a unique identifier, such as for example, an index or code. The identifiers may be part of customer or venue profiles. Computing device 200 or application 2100 thereon may also be associated with a unique identifier or index (e.g. application identifier, device UUID, and the like). A user may be associated with a unique identifier or index, which may be the same of different than the unique identifier of application (e.g. user name, demographic details). For example, multiple users may use application 2100 and may log in using their user identifier or identification information linked to a user identifier. The unique identifiers may be created, stored, transmitted, and/or received by computing device 200, application 2100, and/or a remote computer 3100 and linked to machine readable indicia 110 and data related thereto. For example, the unique identifiers may be part of user, customer or venue profiles. For example, application 2100 can capture machine readable indicia 110 using sensor 250 of computing device 200 and an image recognition process. The application 2100 can link the captured machine readable indicia 110 to unique identifiers. Different combinations of unique identifiers can trigger different responses by application and/or remote computer 3100. For example, a user associated with a user identifier can log into an application 2100 associated with an application identifier, and the application 2100 resides on a computing device 200. The application 2100 and the computing device 200 can capture the machine readable indicia 110 (e.g. via camera or other sensor 250) which is linked to an indicia identifier. The combination of the application identifier, the user identifier, and the indicia identifier can trigger a customized augmented reality experience such as a game with a custom prize. Further, one or more of the identifiers can be used to retrieve historical data regarding the application 2100, user, readable indicia 110, computing device 200 (and data or other applications residing on computing device 200) which may be used to generate a customized augmented reality experience and custom prize, for example. This may increase engagement by system by not providing the same augmented reality experience each time the indicia 110 is captured for each user, or repetitions for the same user. This may be used to ensure that the same user does not receive a prize multiple times for the same readable indicia 110 to encourage the user to purchase additional beverages with lid 100 affixed thereto. Activity data associated with the game can be captured and stored by computing device 200 and/or remote computer 3100 to further customize the augmented reality experience and/or as historical data for subsequent interactions with application 2100, user, readable indicia 110, and computing device 200. Data or other applications residing on computing device 200 such as name, age, sex, geographic location, contact list, social network information and so on may further be used to generate customized augmented reality experiences. The customized augmented reality experiences are dynamic for different applications 2100, users, readable indicia 110, and computing devices 200. The computing device 200 may have specific arrangement of hardware and software computing capabilities for augmented reality experiences and the customized augmented reality experiences can be optimized for the hardware and software computing capabilities of the computing device 200.

Accordingly, a unique identifier may be associated with other unique identifiers and/or readable indicia 110. For example, a user may be associated with a first unique identifier, a computing device 200 may be associated with a second unique identifier, an application 2100 may be associated with a third unique identifier, one or more lids 100 may each be associated with a subsequent unique identifier, and/or one or more lids 100 may each be associated with one or more readable indicia 110 (which in turn may be linked to an identifier). For example, a lid 100 may contain multiple readable indicia 110, each linked to a unique identifier. The specific combination of the multiple readable indicia may be unique to the lid 100 and in turn provide a unique identifier for the lid 100. In some embodiments, said first, second, third, and/or subsequent unique identifiers, and/or readable indicia 110 may be associated with or linked to each other for a dynamic augmented reality experience using computing device 200 and other components. In some embodiments, said association may be created by, stored in, processed by, and/or transmitted by a computing device 200 or a remote computer 3100. For example, a computing device 200 and/or remote computer 3100 may store an association between a unique identifier associated with a user and one or more readable indicia 110 each associated with a lid 100. This association may be used to generate subsequent customized virtual reality experiences and/or retrieve relevant historical data stored by a computing device 200 or a remote computer 3100. Ratings or feedback can also be linked to one or more identifiers.

Embodiments described herein involve data creation, processing, storage, receipt, and transmission to generate customized augmented reality experiences and responses. In some embodiments, computing device 200 may include one or more sensors 250, for example, camera, GPS, accelerometer, gyroscope, compass, magnetometer, proximity sensor, infrared LED, IR light detector, light sensor, barometer, thermometer, air humidity sensor, pedometer, heart rate monitor, fingerprint sensor, capacitive technology, and/or technologies relating to haptics.

In some embodiments, computing device 200 may include a controller 20. Controller 20 may receive data (e.g. data linked to one or more identifiers or the customized augmented reality experience) from a remote computer 3100 and transmit data to a remote computer 3100 (e.g. one or more identifiers, data residing on computing device 200, data linked to readable indicia 110). Controller 20 may store and/or process data from a remote computer 3100 to generate the custom virtual reality experience. Controller 20 may store, process, and/or create local data 2200 to generate the custom virtual reality experience, for example. Controller 20 may receive and/or transmit data to application 2100 and trigger the augmented realty experience. In some embodiments, data received, transmitted, stored, processed, and/or created by controller 20 may relate to or be data processed from one or more readable indicia 110; one or more unique identifiers associated with a lid 100, computing device 200, application 2100, and/or user; data collected via one or more sensors 250; data relating to one or more user responses 400; data relating to one or more events; data relating to contemporaneousness with one or more objects and/or one or more events; data relating to one or more application responses 2400; and/or data relating to location, time, date, user, lid, application and/or computing device. Different combinations of identifiers and events can trigger different augmented reality experiences.

In some embodiments, remote computer 3100 may be a component of a network 300 linked to other hardware and software components used to deliver part of the augmented reality experience. In some embodiments, remote computer 3100 may receive and/or transmit data to computing device 200 to deliver part of the augmented reality experience. Remote computer 3100 may create, process, and/or store data, for example, relating to one or more readable indicia 110; one or more unique identifiers associated with a lid 100, computing device 200, application 2100, and/or user; data collected via one or more sensors 250; data relating to one or more user responses 400; data relating to one or more events; data relating to contemporaneousness with one or more objects and/or one or more events; data relating to one or more application responses 2400; and/or data relating to location, time, date, user, lid, application and/or computing device. The remote computer 3100 transmits data for the augmented reality experiences to computing device 200 in some embodiments.

In some embodiments, application 2100 may receive and/or transmit data to and/or from controller 20. In some embodiments, application 2100 may collect data and/or cause data to be stored by controller 20 and/or by one or more remote computers 3100. For example, application 2100 may collect and/or cause controller 20 and/or remote computer 3100 to store one or more user responses 400. The user responses 400 can trigger different augmented reality experiences.

In some embodiments, user responses 400 may include data relating to or processed from data collected via one or more sensors 250; data collected by, stored in, or accessed by computing device 200; data transmitted by a remote computer 3100 to computing device 200; data collected or accessed by application 2100; and/or data relating to one or more application responses 2400. For example, a user response 400 may comprise a change in location, data received by application 2100 relating to data collected by one or more sensors 250, and/or a change in data relating to user demographics and/or preferences. This updated data can trigger different augmented reality experiences.

In some embodiments, controller 20 or remote computer 3100 may process data by, for example, combining, associating, and/or applying one or more computations to data. The data may be data relating to one or more readable indicia 110; one or more unique identifiers associated with a lid 100, computing device 200, application 2100, and/or user; data collected via one or more sensors 250; data relating to one or more user responses 400; data relating to one or more events; data relating to application responses 2400; and/or data relating to location, time, date, user, lid, application and/or computing device.

For example, controller 20 or remote computer 3100 may process data relating to a unique identifier associated with a user, one or more readable indicia 110, data relating to data collected via one or more sensors 250 relating to location and/or orientation, data relating to the date, data relating to an event; and/or data relating to contemporaneousness with one or more objects and/or one or more events.

In some embodiments, processing of data by controller 20 or remote computer 3100 may include organization or compression of data and/or generation of new data. For example, controller 20 or remote computer 3100 may generate data relating to demographics, computing components, settings and/or preferences using data relating to a user or computing device. For example, data relating to a preference may be created from data relating to one or more user responses 400, for example, data indicating a pattern of user responses 400. For example, a user may select a certain type of advertisement, buy a certain type of product through a virtual store, and/or create a certain pattern of user responses 400 following one or more certain application responses 2400.

Embodiments described herein provide dynamic interactions for user by way of customized augmented reality experiences and responses. Application 2100 may select and/or create one or more application responses 2400 via an actuating mechanism 2300 to generate the customized virtual reality experience and/or prize award. The actuating mechanism 2300 may include a feedback loop and/or machine learning process based on local data 2200 and/or data received from a remote computer 3100 to further refine the customization of virtual reality experience, prize award, object recognition (of readable indicia 110) and user preference pattern detection. In some embodiments, the actuating mechanism 2300 involves the transmission and/or receipt of data to and/or from a remote computer 3100 to and/or from a controller 20 and/or to and/or from an application 2100, triggering of an audio notification, triggering of a visual notification, and so on. The data may be processed by said controller 20 and/or remote computer 3100 and may then actuate one or more application responses 2400.

In some embodiments, an application response 2400 may be transmission and/or processing of data by controller 20 for augmented reality experiences. In some embodiments, an application response 2400 may be a change of or presentation of a display and/or the presentation of audio for augmented reality experiences. In some embodiments, said display may be an advertisement, game, prompt, notification, survey, virtual store, virtual overlay, and/or augmented reality. For example, the notification may alert a user that said user has won a prize.

The data for the augmented reality experiences can be linked to one or more readable indicia 110; number of readable indicia 110; one or more unique identifiers associated with a lid 100, computing device 200, application 2100, and/or user; data collected via one or more sensors 250; one or more user responses 400; one or more events; application responses 2400; and/or location, time, date, user, lid, application and/or computing device. For example, data relating to user may include data relating to a unique identifier, history of said user's responses 400 relating to the application 2100, said user's personal information, for example, stored by the application 2100 or originating from other applications in a computing device 200 or received from a remote computer 3100 or accessed by or stored in a computing device 200.

In some embodiments, different readable indicia create different responses or augmented reality experiences. In some embodiments, application 2100 may actuate a first application response 2400, for example, the presentation of a virtual store on a computing device 200, using actuating mechanism 2300 based on a specific combination of a first readable indicia 110 and a unique identifier associated with a user, data relating to the user's personal information, one or more past user responses 400 relating to the application 2100, or data relating to an event. In some embodiments, application 2100 may actuate a second application response 2400, for example, the presentation of a different virtual store or the display of an augmented reality on a computing device 200, using actuating mechanism 2300 based on a second or additional readable indicia 110 and said unique identifier associated with a user, said data relating to said user's said personal information, said user response 400 or user responses 400 relating to the application 2100, and said data relating to an event.

In some embodiments, the same readable indicia, but different user information or preferences can create different responses or augmented reality experiences: In some embodiments, application 2100 may actuate a first application response 2400, for example, the display of an advertisement, game or prize on a computing device 200 and/or the presentation of audio and visual elements through a computing device 200, using actuating mechanism 2300 based on data relating to a readable indicia 110 and data relating to a user's personal information, demographics and/or preferences. In some embodiments, application 2100 may actuate a second application response 2400, for example, the display of a different presentation of audio and visual elements on a computing device 200 and/or the presentation of different audio through a computing device 200, using actuating mechanism 2300 based on said readable indicia 110 and different data relating to a user's personal information and/or different data relating to demographics and/or preferences.

In some embodiments, the same readable indicia, but different event, geo-fenced location, and/or time create different responses or augmented reality experiences. For example, application 2100 may actuate a first application response 2400, for example, the display of an advertisement on a computing device 200 and/or the presentation of audio through a computing device 200 and/or the presentation of a virtual store and/or the presentation of an augmented reality, using actuating mechanism 2300 based on data relating to a readable indicia 110 and data relating to an event, location, and/or time. In some embodiments, application 2100 may actuate a second application response 2400, for example, the display of a different advertisement on a computing device 200 and/or the presentation of different audio through a computing device 200 and/or the presentation of a different virtual store and/or the presentation of a different augmented reality, using actuating mechanism 2300 based on said readable indicia 110 and different data relating to an event, location, and/or time.

In some embodiments, multiple lids 100 and machine readable indicia 110 create different responses: The application 2100 may actuate a first application response 2400, for example, the display of an advertisement on a computing device 200 and/or the presentation of audio through a computing device 200 and/or the presentation of a virtual store and/or the presentation of an augmented reality, based on data relating to a readable indicia 110 and/or a unique identifier related to a lid. In some embodiments, application 2100 may actuate a second application response 2400, for example, the display of a different advertisement on a computing device 200 and/or the presentation of different audio through a computing device 200 and/or the presentation of a different virtual store and/or the presentation of a different augmented reality, based on data relating to a readable indicia 110 and/or a unique identifier related to a lid as well as one or more additional readable indicia 110 and/or one or more unique identifiers related to a lid and/or the number of readable indicia 110 associated with a user and/or the number of unique identifiers related to a lid and associated with a user.

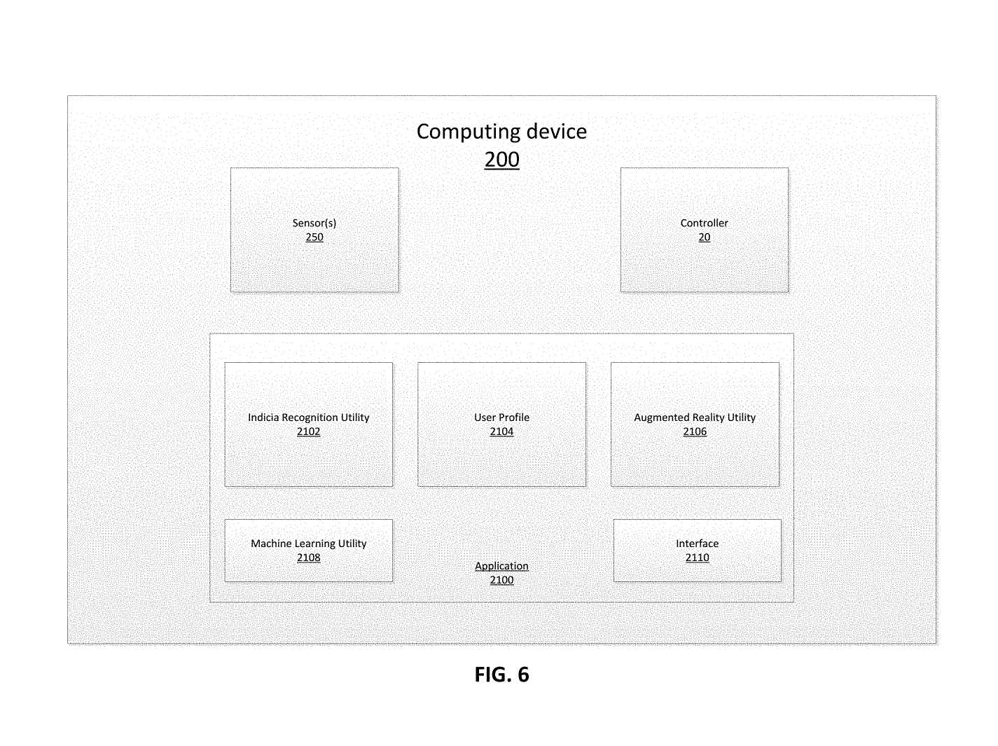

FIG. 6 is a schematic of computing device according to some embodiments. Computing device 200 includes sensors 250 to capture the indicia 110 from lid 100. The controller 200 interacts with components of device 200 and remote computer 3100 to capture indicia 110 in some embodiments.

Application 2100 includes functionality utilities such as indicia recognition utility 2102, machine learning utility 2108, and augmented reality utility 2106. Application 2100 also generates and updates user profile 2104 with data from device 200, indicia data, image data, demographics, user data, and activity data relating to the augmented reality session. Application 2100 interacts with remote computer 3100 to exchange data from user profile. Application 2100 has interface to interact with other devices, and generate graphical representations for visual effects and control signals to trigger other effects.

Machine learning utility 2108 interacts with remote computer 3100 to refine and update recognition process for the indicia recognition utility 2102. Machine learning utility 2108 interacts with remote computer 3100 to train on remote data repositories. Machine learning utility 2108 receives feedback and confirmation for the indicia 110 to further update training set and recognition process. Machine learning utility 2108 provides feedback and confirmation to remote computer 3100. Machine learning utility 2108 interacts with remote computer 3100 to receive suggested user configurations and elements for the augmented reality experience based on demographic and location data. Machine learning utility 2108 detects identifiers for different capture events to trigger different actions for the augment reality experience. For example, machine learning utility 2108 detects device identifier, user identifier and indicia 110 to suggest elements for a customized augmented reality experience based on similar users, devices, indicia, feedback, and so on.

Augmented reality utility 2106 triggers other components to generate elements of the augmented reality experience. Augmented reality utility 2106 receives suggested elements for the augmented reality experience from machine learning utility 2108. Augmented reality utility 2106 uses the detected indicia 110 to program the elements of augmented reality experience. Augmented reality utility 2106 generates a custom augmented reality experience based on the indicia 110, identifiers, user profile 2104, data from remote computer 3100, and suggested elements from machine learning utility 2108. Augmented reality utility 2106 triggers delivery of augmented reality content. Augmented reality utility 2106 triggers different augmented reality content for different geo-fenced locations, for example.

For example, sensors 250 capture a digital image of the lid 100 to trigger an action (e.g. coupons, advertisement, video) on device 200 as part of a custom augmented reality experience. Indicia recognition utility 2102 implements an object recognition process to detect indicia 110 from the image of the lid 100. Indicia recognition utility 2102 can crop the image to tightly include the lid 100 to filter out background. Indicia recognition utility 2102 can crop the image to tightly include the indicia 110 to filter out background. Indicia recognition utility 2102 can generate a digital signature for the image of the lid 100 to detect one or more indicia 110 therein. Indicia recognition utility 2102 can generate a refined digital signature for the indicia 110 once its position is detected and defined. Indicia recognition utility 2102 accesses known digital signature for indicia 110 to facilitate the detection process by looking for known patterns within the image of the lid 100. Indicia recognition utility 2102 can use histograms to generate the digital signatures or patterns, for example. Indicia recognition utility 2102 can process images of different types of lids 100 and recognize different types of indicia 110. Indicia recognition utility 2102 is configured to recognize objects (including indicia 110) on three dimensional surfaces and contours. It may be harder to detect objects (including indicia 110) from a lid 100 due to contours of lid (three dimensional surface) the size of the image, configuration of the image, lighting in the venue, interference with sensors 250, movement by the user and the like. Indicia recognition utility 2102 is configured to error correct.

Remote computer 3100 provides the ability for a stadium to be geo-fenced and identify the devices 200 (and applications 2100) that are within the stadium or other geo-fenced region. Remote computer 3100 can track at the device level and at the application level. Devices 200 can be identified by device number (e.g. an identifier based on the type of phone), application code, and user identifier and information about the user. Remote computer 3100 can passively track users and devices 200. Application 2100 provides an interface to capture an image of the lid 100 to read the indicia 110. The indicia 110 may be one or more images, for example, each image linked to a particular digital signature. The indicia 110 may be different images. The indicia 110 may be linked to customers or venues. Different indicia 110 may be used for different customers and different venues. The digital signature can be derived by processing an image containing the indicia 110, for example. Application 2100 monitors activity at device 200 to provide rich data sets to the remote computer 3100. Application 2100 access data at device 200 to provide rich data sets to the remote computer 3100.

The device 200 and application 2100 deliver an augmented reality experience to the user based on the lid 100, the indicia 110, the geo-fence location. The device 200 and application 2100 collect metadata about the user and device 200. This allows the owner of the geo-fenced area to view devices 200 through a dashboard (via GPS tracking) on an interface of display, for example. The device 200 and application 2100 pull information from social media accounts. The device 200 cannot send notifications to user without the application, in some examples. This system configuration can enable data collection without an application on all devices to enrich the marketing data set. This enables layering of the marketing data to the location data (e.g. seat plans). This system configuration can also enable layering of the inventory data (e.g. person X bought 3 beers with enhanced lids 100 but only engaged with AR experience 1 time and user may be identified at time of transaction).

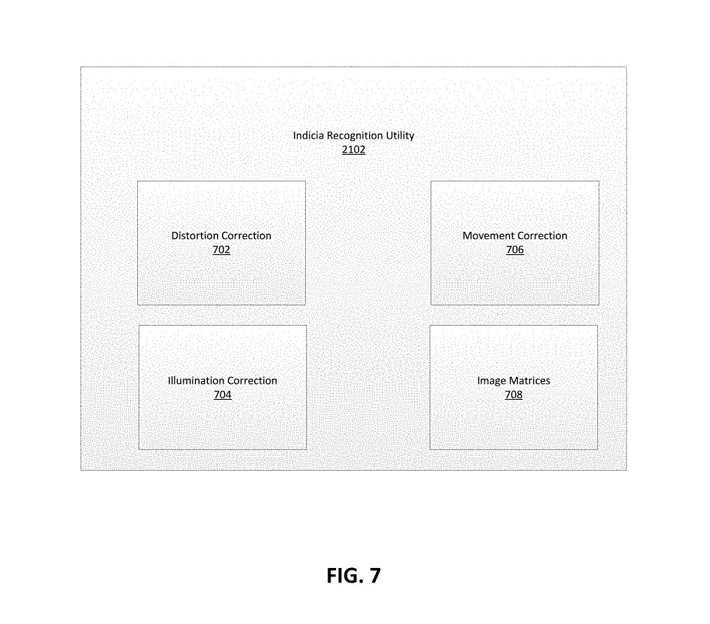

FIG. 7 is a schematic of indicia recognition utility 2102 according to some embodiments.

Indicia recognition utility 2102 can process images of different types of lids 100 and recognize different types of indicia 110. Indicia recognition utility 2102 is configured to recognize objects (including indicia 110) on three dimensional surfaces and contours. It may be harder to detect objects (including indicia 110) from a lid 100 due to contours of lid (three dimensional surface) the size of the image, configuration of the image, lighting in the venue, interference with sensors 250, movement by the user and the like. Indicia recognition utility 2102 can detect indicia 110 by reading an image than other readable indicia (e.g. barcode). Further, indicia recognition utility 2102 can detect indicia 110 by reading an image of off a contoured surface.

Indicia recognition utility 2102 has distortion correction 702 to filter out and transform image data that are captured at angles, partially obstructed, or otherwise distorted to facilitate the object detection process. Indicia recognition utility 2102 has movement correction to filter and transform image data that is distorted through movement during capture which may be common if the user is moving and socially interacting. Indicia recognition utility 2102 has illumination correction to detect illumination conditions and correct image data if the lighting is dark, and the like. Indicia recognition utility 2102 has image matrices 708 that link image data to digital patterns, elements of augmented reality, customers, venues, users, devices, and the like.

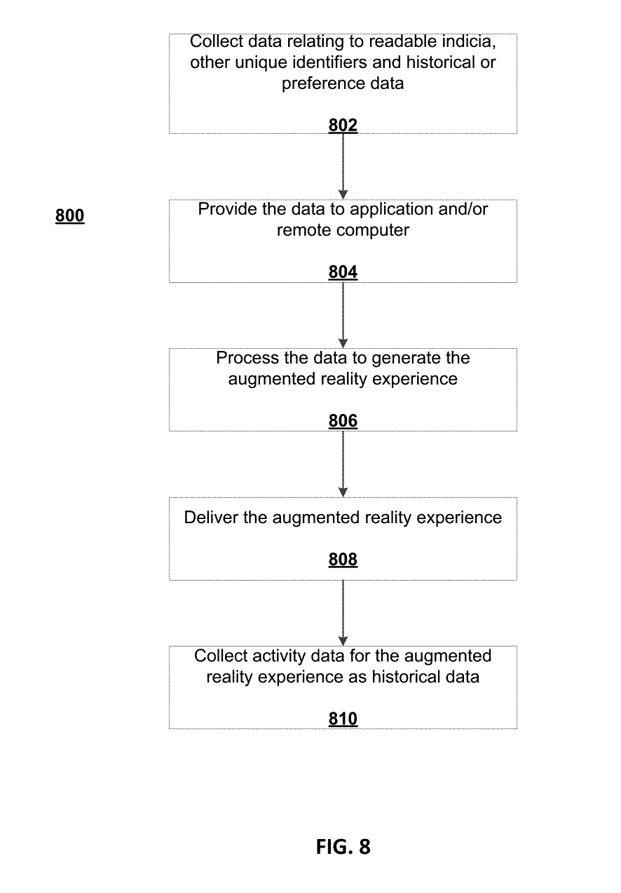

FIG. 8 is a workflow diagram of an example augmented reality process 600 involving lids 100 for beverage containers according to some embodiments.

At 802, the computing device 200 collects data relating to readable indicia 110, other unique identifiers and historical or preference data. For example, a controller 20 may collect, store, receive and/or transmit data relating to, for example, a unique identifier related to a user, a user, a user's personal information, one or more user responses 400, and/or data relating to demographics and/or preferences. The receipt and/or transmission may be to and/or from a remote computer 3100 and/or an application 2100. The computing device 200 uses sensors and implements object recognition to capture readable indicia 110 in some embodiments. For example, the computing device 200 uses histograms of a segment of an image depicting the readable indicia 110 to generate a digital signature and determines a link to a known digital signature. The known digital signature may in turn to be linked to other data sets to enhance the user augmented reality experience and the graphical representations for the customer dashboard interface to interact with visual representations of the data collected through the process. The dashboard can also include control features to modify and direct the augmented reality experience, for example.

At 804, the computing device 200 provides the data to application 2100 and/or remote computer 3100. An application 2100 may receive and/or cause to be stored and/or cause to be transmitted data relating to, for example, a unique identifier related to a user, user demographics, device information, one or more user responses 400, and/or data relating to other demographics and/or preferences. The storage and/or said transmission of data may be performed by controller 20.

A remote computer 3100 may collect, store, receive and/or transmit data relating to, for example, a unique identifier related to a user, a user, a user's personal information, one or more user responses 400, and/or data relating to demographics and/or preferences. The receipt and/or transmission may be to and/or from a controller 20. The remote computer 3100 may also perform aspects of pattern matching to compare the digital signature of the indicia 110 to known digital signatures as part of the object recognition process.

The application 2100 may cause a controller 20 to process captured data to generate the digital signature and augmented reality experience. The application 2100 may cause a controller 20 to connect to other devices and systems to exchange data and trigger effects.

At 806, the computing device 200 or the remote computer 3100 processes the data to generate the augmented reality experience. For example, different combinations of identifiers, profiles, preferences and historical data can generate different customized augmented reality experiences. Application 2100 responses change based on new data (but triggered by readable indicia 110) and are used to deliver custom augmented reality experiences. For example, an application 2100 may create and/or select one or more first application responses 2400, for example, the presentation of an advertisement, based on data and/or processed data, including relating to at least one readable indicia 110, via an actuating mechanism 2300. Said application 2100 may collect and/or receive new data and/or new processed data. Said application 2100 may then create and/or select one or more second application responses, for example, the presentation of a different advertisement, based on said new data and/or said new processed data as well as data relating to at least one readable indicia 110.

At 808, computing device 200 and/or remote computer 3100 deliver the augmented reality experience using actuating mechanism or other hardware and software components. For example, the device 200 may be in a stadium and the augmented reality experience may involve audio, video or tactile effects.

At 810, computing device 200 and/or remote computer 3100 collect activity data for the augmented reality experience as historical data. For example, the augmented reality experience can involve a game or prize and the activity data can relate to game play based on user input and game events. As another example, augmented reality experience can involve an interactive survey and the activity data can relate to responses to the interactive survey. The activity data can also relate to user feedback on the augmented reality experience or machine learning results based on pattern detections related to user.

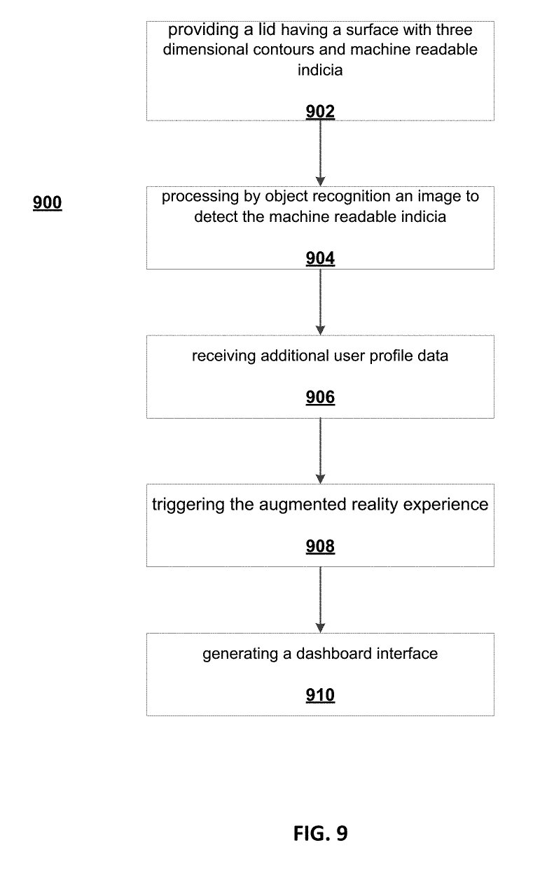

FIG. 9 shows a process for generating a customized augmented reality experience. Device 200 can be virtual reality device or other mobile device 200 with sensors to capture indicia 110 from lid 100.

At 902, the process involves providing a lid 100 having a surface with three dimensional contours and machine readable indicia 110 to a consumer with a device 200 located in the geo-fenced area.

At 904, the process involves capturing readable indicia 110 using device 200. For example, the device 200 can capture a series of images of lid 100 and readable indicia 110. The device 200 is configured to process by object recognition the image data to detect the machine readable indicia 110 from the surface with three dimensional contours. The device 200 captures the image within a geo-fenced region, for example. The device 200 can interact with remote computer 3100 for the detection process, such as by comparing a digital signature to known digital signatures at computer 3100.

At 906, the device 200 or remote computer 3100 receives additional user profile data. This can be demographic data local to device 200 or applications thereon, for example. This may be user or device data, time or environment data, for example. Device 200 has sensors 250 to generate various data metrics for example. Remote computer 3100 processes tracking data regarding devices within the geo-fenced region to generate comparative metrics for the device 200 that captured the image of the indicia 100. This may provide additional profile data.

At 908, remote computer 3100 or device 200 triggers an augmented reality experience based on the detected machine readable indicia 110, the additional user profile data, the tracking data, and the comparative metrics. The augmented reality experience involving actuators to impart a physical effect within the geo-fenced zone, for example. The augmented reality experience may be enhanced or impacted by other devices to provide an interactive experience, for example.

At 910, the remote computer 3100 generates a dashboard interface for providing visual representations of the tracking data regarding devices within the geo-fenced region, the user profile data, and the comparative metrics for the device that captured the image. The dashboard interface provides a mechanism to control aspect of augmented reality experience and review a rich data set including various graphical representations of the data set.

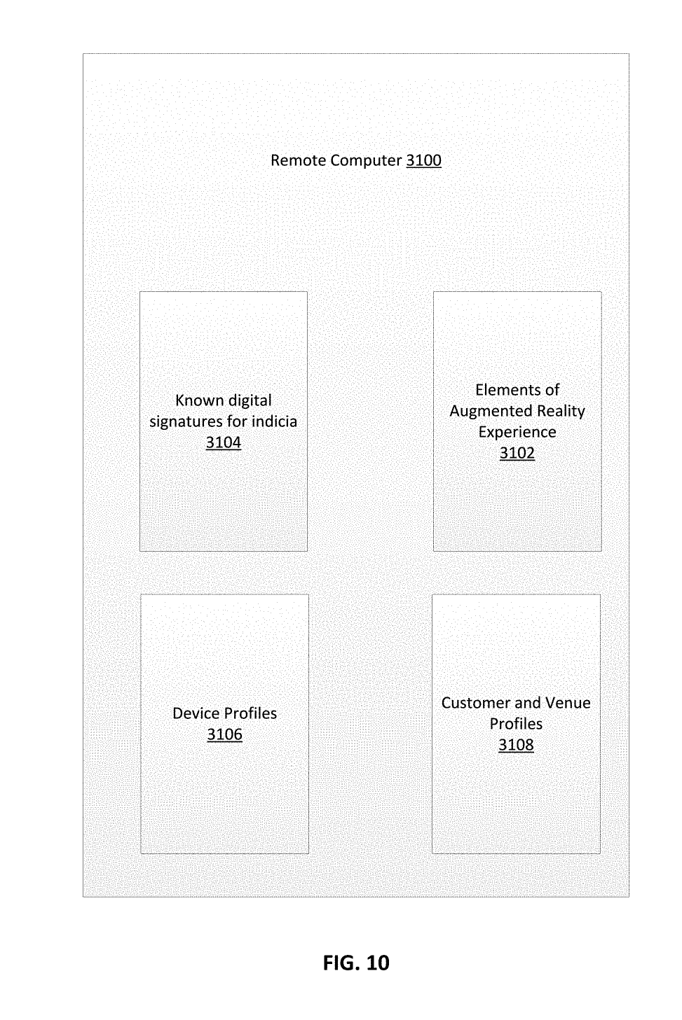

FIG. 10 is a schematic of a remote computer 3100 according to some embodiments.

A remote computer 3100 maintains accounts linked to devices 200 as device profiles 3106. The data may be collected through the passive tracking process within the geo-fenced area, device 200 local data and application data, third party data feeds, interactions with lid 100, indicia 110, augmented reality experiences, and so on. An account includes an identification of the device 200. The remote computer 3100 manages a geo-fence around an area, such as an establishment or stadium. The remote computer 3100 locates the stadium on a coordinate system and establishes an electronic boundary around the stadium located on the coordinate system. The remote computer 3100 receives information identifying the location of the device 200. The remote computer 3100 determines whether the device 200 is within the boundary established about the establishment. If it is determined that the device 200 is within the boundary established about the establishment, transmitting a signal to the device 200 to activate a location module. The remote computer 3100 receives a position of the device 200 from the location utility (e.g. application that integrates with sensors including GPS). The remote computer 3100 identifies the position of the device 200 about the boundary area.

The remote computer 3100 also maintains a repository of known digital signatures for indicia 3104. This enables remote computer 3100 to interact with device 200 to facilitate object recognition and detection/verification of indicia 100. Some known digital signatures for indicia 3104 can be distributed to device 200, for example. The remote computer 3100 can update the known digital signatures for indicia 310 and link them to data records, metadata, and customer, for example to provide network of reference pointers.

The remote computer 3100 also maintains a repository of customer and venue profiles 3108. This includes data structures defining specific physical areas and regions, such as stadium maps, seat maps, points of interest, network beacons, actuating mechanisms, and the like. The customer and venue profiles 3108 include details regarding devices and components that are engaged to deliver the augmented reality experience, including identifiers, communication protocol, message formatting, specifications, and the like. The customer and venue profiles 3108 can link to elements 3102 of augmented reality experiences which can be combined for different effects. The elements 3102 include control instructions to impact and control different actuating mechanisms, for example.

The discussion herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following section describes potential applications that may be practiced in regards to some embodiments. There may be other, different, modifications, etc. of the below potential applications, and it should be understood that the description is provided as non-limiting, illustrative examples only. For example, there may be additions, omissions, modifications, and other applications may be considered.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. An augmented reality process comprising:
providing a lid having a surface with three dimensional contours and machine readable indicia, the machine readable indicia being contoured by the surface with three dimensional contours;
processing by object recognition an image to detect the machine readable indicia from the surface with three dimensional contours, the image captured at a device within a geo-fenced region;
receiving additional user profile data from the device;
processing tracking data regarding devices within the geo-fenced region to generate comparative metrics for the device that captured the image based on the tracking data, data linked to the machine readable indicia, and the additional user profile data;
triggering, at the device or at another device within the geo-fenced region, an augmented reality experience based on the detected machine readable indicia, the additional user profile data, the tracking data, and the comparative metrics, the augmented reality experience involving actuators to impart a physical effect; and
generating a dashboard interface for providing visual representations of the tracking data regarding devices within the geo-fenced region, the user profile data, and the comparative metrics for the device that captured the image.

2. The augmented reality process of claim 1 further comprising printing an image on the surface; and forming the surface of the lid to generate the machine readable indicia from the printed image and the three dimensional contours, the lid configured to seal or secure to a beverage container.

3. The augmented reality process of claim 2 further comprising receiving a configuration file to configure a machine for the printing the image on the surface based on a customer identifier, the customer identifier linked to the geo-fenced region and the augmented reality experience.

4. The augmented reality process of claim 2 further comprising receiving a configuration file to configure a machine for the printing the image on the surface based on a region identifier, the region identifier linked to a sub-region of the geo-fenced region.

5. The augmented reality process of claim 1 further comprising
collecting data relating to the readable indicia and one or more unique identifiers for the device and historical or preference data from the device for the user profile data;
providing the data to an application and/or a remote computer;
processing the data to generate control data to trigger different devices to execute aspects the augmented reality experience;
delivering the augmented reality experience using the application and/or the remote computer; and
collecting activity data for the augmented reality experience; and
updating the augmented reality experience based on the collected activity data.

6. The augmented reality process of claim 1 further comprising processing the image to detect the machine readable indicia from the surface with three dimensional contours using distortion correction to flatten the image and calculating the variation of the contours for the distortion correction.

7. The augmented reality process of claim 1 further comprising processing the image to detect the machine readable indicia from the surface with three dimensional contours using movement correction to accommodate blurring of the image.

8. The augmented reality process of claim 1 further comprising processing the image to detect the machine readable indicia from the surface with three dimensional contours using illumination correction to accommodate darkening of the image.

9. The augmented reality process of claim 1 further comprising updating the augmented reality experience based on machine learning to detect patterns in the collected activity data in comparison to known patterns linked to different augmented reality events.

10. The augmented reality process of claim 1 further comprising processing the image to detect the machine readable indicia from the surface with three dimensional contours by generating an image profile and comparing to known image profiles.

11. The augmented reality process of claim 1, wherein the augmented reality experience triggers actions by device to playback or distribute a digital media asset, the digital asset selected based on collected activity data or the user profile data.

12. An augmented reality system comprising:
a computing device with a capture device and an application to capture and process machine readable indicia from a lid having a surface with three dimensional contours, the capture device configured to capture a series of images of the lid, the application configured to detect the machine readable indicia on the surface with three dimensional contours and one or more unique identifiers; and
a remote server configured to:
processing tracking data regarding devices within the geo-fenced region to generate comparative metrics for the device that captured the image based on the tracking data, data linked to the machine readable indicia, and the one or more unique identifiers;
generate a customized augmented reality experience based on the one or more unique identifiers, the tracking data, and data linked to the machine readable indicia; and
generate and dynamically update a dashboard interface for providing visual representations of the tracking data regarding devices within the geo-fenced region, the user profile data, and the comparative metrics for the device that captured the image, the dashboard interface configured to control the generation of the comparative metrics.

13. The system of claim 12 further comprising the lid with the machine readable indicia and the three dimensional contour.

14. The system of claim 12 wherein the remote server is further configured to:
collect data relating to the readable indicia and the one or more unique identifiers for the device and historical or preference data from the device for user profile data;
process the data to generate control data to trigger different devices to execute aspects the augmented reality experience;
deliver the augmented reality experience using the control data, the application, and a remote computer; and
collecting activity data for the augmented reality experience; and
updating the augmented reality experience based on the collected activity data.

15. The system of claim 12 wherein the application is configured to process the image to detect the machine readable indicia from the surface with three dimensional contours using distortion correction to flatten the image and calculating the variation of the contours for the distortion correction.

16. The system of claim 12 wherein the application is configured to process the image to detect the machine readable indicia from the surface with three dimensional contours using movement correction to accommodate blurring of the image.

17. The system of claim 12 wherein the application is configured to process the image to detect the machine readable indicia from the surface with three dimensional contours using illumination correction to accommodate darkening of the image.

18. The system of claim 12 wherein the application is configured to process the image to detect the machine readable indicia from the surface with three dimensional contours by generating an image profile and comparing to known image profiles for the machine readable indicia.

19. The system of claim 12 wherein the remote server is further configured to update the augmented reality experience based on machine learning to detect patterns in the collected activity data in comparison to known patterns linked to different augmented reality events.

20. An augmented reality process comprising:
capturing a series of images of a surface of a lid with three dimensional contours;
collecting data relating to readable indicia and one or more unique identifiers and historical or preference data;
providing the data to an application and/or a remote computer;
processing the data to generate an augmented reality experience;
delivering the augmented reality experience using the application and/or the remote computer;
collecting activity data for the augmented reality experience; and
updating the augmented reality experience based on the collected activity data.
